(19) United States
(12) Patent Application Publication
(10) Pub. No.: US 2023/0329210 A1
(43) Pub. Date: Oct. 19, 2023

(54) FISHING ROD HOLDER

(71) Applicant: KIP LEE MURPHY, PUNTA GORDA, FL (US)

(72) Inventor: KIP LEE MURPHY, PUNTA GORDA, FL (US)

(21) Appl. No.: 17/849,597

(22) Filed: Jun. 25, 2022

Related U.S. Application Data
(63) Continuation-in-part of application No. 29/834,574, filed on Apr. 13, 2022.

(51) Int. Cl. A01K 97/10

(52) U.S. Cl. CPC A01K 97/10

(57) ABSTRACT

A fishing rod holding device (1) having a first leg (4) connected by connector section (5) to a forward second leg (6) having a fishing rod holder (7) adjustably attached proximate a bottom thereof. The device may have a stem (12) at a bottom of the first leg for insertion into a preinstalled fishing rod holder on a boat or, alternatively, an integral holder if mounted on a boat.

### CROSS-REFERENCE TO RELATED APPLICATION

This application claims priority to patent application Ser. No. 29/834,574 filed on Apr. 13, 2022, which is currently pending. The patent application identified above is incorporated herein by reference in its entirety to provide continuity of disclosure.

### BACKGROUND OF THE INVENTION

The present invention relates to a sport fishing rod holder extension that mounts in an elevated holder of a center console of a boat and has a lower extension that has a fishing rod holder that allows a normally elevated fishing rod to be held at a level where it can be easily and safely grasped and handed to a fisherman who has a fish on a long shotgun line or short shotgun line.

The conventional practice employed in sport fishing boats having a center console or day boat with T-top is to place the fishing rods in elevated fishing rod holders. In order to reach and retrieve a fishing rod one must stand up and to remove a fishing rod from the elevated holder. Unfortunately, the latter conventional practice can present a problem when trolling for fish using a shotgun line as once a fish is hooked, someone must remove the fishing rod from the elevated holder and hand it to a fisherman to fight and bring in and land the fish. Removing a fishing rod from an elevated holder can be dangerous, especially in rough seas as the person retrieving the fishing rod must stand and balance oneself when doing so and could even be thrown from the boat.

Thus, a need exists for a fishing rod holding device that is safe and convenient to use in such situations. The prior art is devoid of any device like the present invention that attempts to solve the above problem.

### SUMMARY OF THE INVENTION

The primary object of the present invention is to provide a fishing rod holding device that is safe to use.

Another object of the present invention is to provide such a fishing rod holding device that that is convenient to use.

A further object of the present invention is to provide such a fishing rod holding device that can be used with current fishing rod holders or installed as a stand-alone fishing rod holder.

The present invention fulfills the above and other objects by providing a fishing rod holding device having a first leg with a rod holder stem at a bottom and a second leg connected forward of the first leg by a connecting section. The second leg has a fishing rod holder attached proximate a bottom thereof. The fishing rod holding device of may be integrated to form one piece. The fishing rod holder may be height adjustably attached to the second leg by a bracket. The fishing rod holder device may have a stem at the bottom of the first leg for insertion into a preinstalled fishing rod holding base on a boat or a base for mounting the device to a boat.

The above and other objects, features and advantages of the present invention should become even more readily apparent to those skilled in the art upon a reading of the following detailed description in conjunction with the drawings wherein there is shown and described illustrative embodiments of the invention.

### DESCRIPTION OF THE DRAWINGS

In the following detailed description, reference will be made to the attached drawings in which:

FIG. 1 is a side partial perspective view of one fishing rod holding device of the present invention installed on a boat with a fishing rod;

FIG. 2 is a side partial perspective view of the fishing rod holding device of the present invention;

FIG. 3 is a front view of the fishing rod holding device of the present invention;

FIG. 4 is a rear view of the fishing rod holding device of the present invention; and

FIG. 5 is a rear view of the fishing rod holding device of the present invention.

### DESCRIPTION OF THE PREFERRED EMBODIMENTS

For purposes of describing the preferred embodiment, the terminology used in reference to the numbered items in the drawings is as follows:
1. fishing rod holder device, generally
2. boat
3. base of boat rod holder
4. first leg of 1
5. leg connector
6. second leg
7. rod holder
8. rod holder attachment bracket
9. fishing rod
10. top aperture of 8
11. rod seat bolt
12. rod holder stem

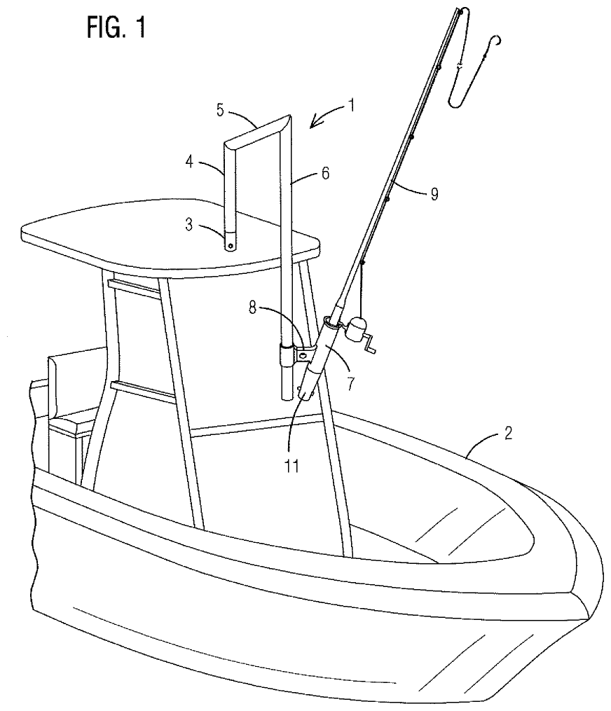

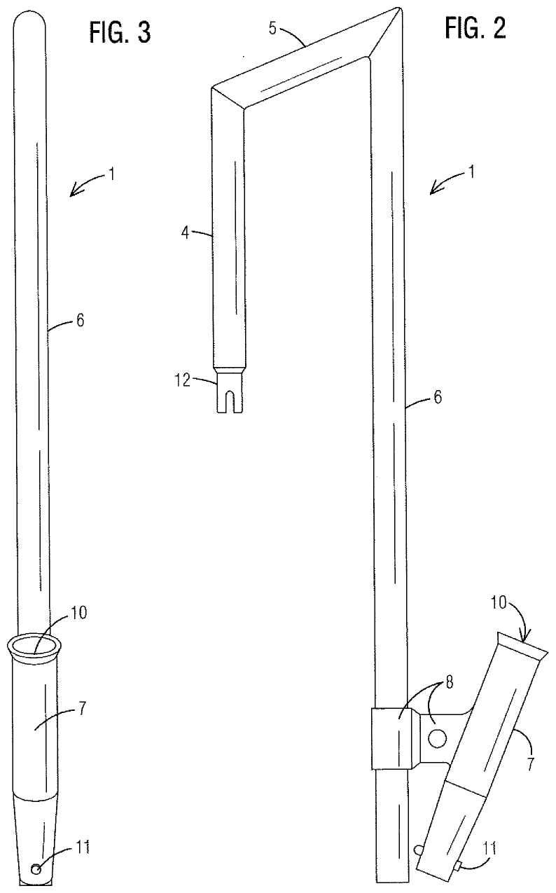

Referring now to the FIG. 1, a perspective view of the fishing rod holder device 1 of the present invention is illustrated as it might appear when in use on a boat 2. The fishing rod holder device 1 has a base 3, which may be already installed on the boat when the fishing rod holder device 1 is being used on an existing boat or made part of the fishing rod holder device 1 if manufactured into a boat. As illustrated the fishing rod holder device 1 has a first leg 4 with a stem 12 (as shown in FIG. 2 for insertion into the rod holder base 3 and a second leg 6 connected to the first leg 4 by a connector section 5. The length of the two legs 4 and 6 may vary just so long as the second leg 6 has sufficient length so the device rod holder 7 attached to the second leg by bracket 8 is low enough that a fishing rod 9 is at such a height that a fishing rod can be easily, quickly and safely removed from the holder 7 when necessary. Although the fishing rod holder device 1 is illustrated as having separate legs 4 and 6 and connecting section 5, the fishing rod holder device 1 could be made of one piece and even be curvilinear in shape.

FIG. 2 depicts a side view of the fishing rod holder device 1 denoting the same components previously discussed in relation to FIG. 1, namely the first leg 4 with stem 12 connected to a second leg 6 by connector 5. The rod holder 7 with rod aperture 10 is height-adjustably attached to the second leg 6 by bracket 8 at a desired height for easy, quick and safe removal of a fishing rod as needed.

FIG. 3 illustrates a front view of the fishing rod holder device 1 showing the second leg 6 with rod holder cup 7 proximate a bottom thereof with rod aperture 10 at the top and rod seat bolt 11 at the bottom.

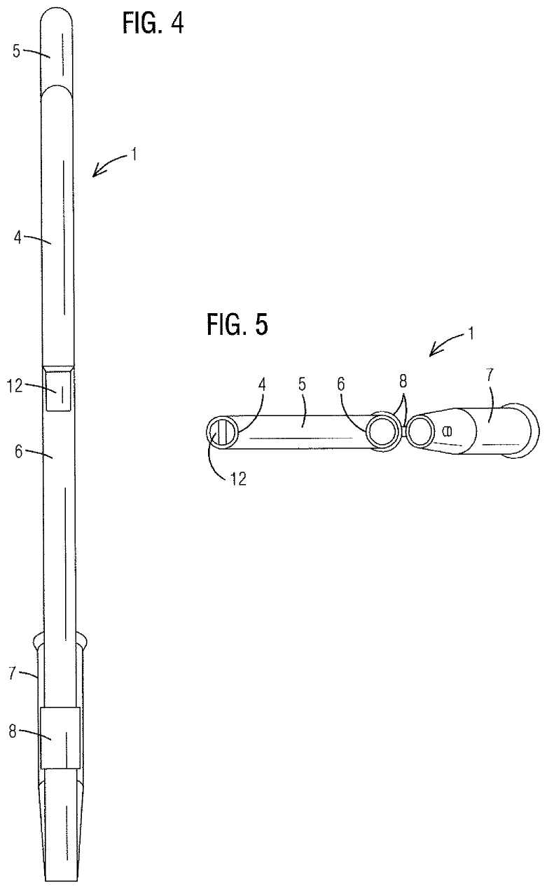

FIG. 4 illustrates a rear view of the fishing rod holder device 1 with first leg 4 with bottom stem 12 connected by connector section 5 to the second leg 6 bearing the rod holder 7 with bracket 8 attached at a desired location proximate the bottom thereof.

The final illustration in FIG. 5 illustrates a bottom view of the fishing rod holder device 1 with first leg 4 connected by connector 5 to second leg 6 as it might appear when made of one piece with stem 12 at the bottom of the first leg 4 and fishing rod holder 7 attached by bracket 8 proximate the bottom of the second leg 6.

Although several aspects have been disclosed in the foregoing specification, it is understood by those skilled in the art that many modifications and other aspects will come to mind to which this disclosure pertains, having the benefit of the teaching presented in the foregoing description and associated drawings. It is thus understood that the disclosure is not limited to the specific aspects disclosed hereinabove, and that many modifications and other aspects are intended to be included within the scope of any claims that can recite the disclosed subject matter.

Having thus described my invention, I claim:

1. A fishing rod holder device comprising:
a first leg having a rod holder stem at a bottom; and
a second leg connected forward of the first leg by a connecting section, said second leg having a fishing rod holder attached proximate a bottom thereof.

2. The fishing rod holder device of claim 1 wherein the first leg, second leg and connector section are integrated to form one piece.

3. The fishing rod holder device of claim 1 wherein the rod holder stem of
the first leg has a notch for securing over a preinstalled rod holder on a boat.

4. The fishing rod holder device of claim 1 wherein the fishing rod holder is height adjustably attached to the second leg by bracket.

5. A fishing rod holder device comprising:
a first leg having a base for mounting on a boat; and
a second leg connected forward of the first leg by a connecting section, said second leg having a fishing rod holder attached proximate a bottom thereof.

6. The fishing rod holder device of claim 5 wherein the first leg, second leg and connector section are integrated to form one piece.

7. The fishing rod holder device of claim 5 wherein the fishing rod holder is height adjustably attached to the second leg by bracket.
